(19) United States
(12) Patent Application Publication
(10) Pub. No.: US 2017/0004437 A1
(43) Pub. Date: Jan. 5, 2017

(54) SYSTEMS, APPARATUS AND METHODS FOR GENERATING AND DISPLAYING A SCHEDULE IMPACT MAP

(71) Applicant: HTS, Inc., Emeryville, CA (US)

(72) Inventors: William Clemenson, San Francisco, CA (US); Bernhard Kamps, Albany, CA (US)

(73) Assignee: HTS, Inc., Emeryville, CA (US)

(21) Appl. No.: 15/269,011

(22) Filed: Sep. 19, 2016

Related U.S. Application Data
(63) Continuation-in-part of application No. 15/247,884, filed on Aug. 25, 2016.
Application No. 15/247,884 is a continuation of application No. 14/920,810, filed on Oct. 22, 2015, now Pat. No. 9,454,742.
Application No. 14/920,810 is a continuation of application No. 13/802,213, filed on Mar. 13, 2013, now Pat. No. 9,202,390.
(60) Provisional application No. 62/220,807, filed on Sep. 18, 2015.

(51) Int. Cl. G06Q 10/06; G06T 11/00; G06Q 50/16; G06T 11/20

(52) U.S. Cl. CPC G06Q 10/063114; G06T 11/206; G06T 11/001; G06Q 10/06395; G06Q 50/165

(57) ABSTRACT

A map of a building project is received, the map including a structure and one or more defined spaces within the structure. An indication of one or more products to be delivered to the one or more defined spaces is received. A visual map of the building project is generated. For each of the one or more products to be delivered, a target date is assigned to a category assigned to the product. Differences between a current date and the target dates are determined, and a color is selected for a respective defined space on the visual map based on the difference. The visual map is displayed, with the selected color being displayed in a respective defined space.

### CROSS REFERENCE TO RELATED APPLICATIONS

This application is a continuation-in-part of application Ser. No. 15/247,884 filed Aug. 25, 2016, this application being a continuation of U.S. patent application Ser. No. 14/920,810, filed Oct. 22, 2015, which claims priority as a continuation of U.S. patent application Ser. No. 13/802,213, filed Mar. 13, 2013, and the present application also claims the benefit of, and priority to, U.S. Provisional Application No. 62/220,807, filed on Sep. 18, 2015, all of these applications being hereby incorporated by reference in their entirety for all purposes.

### BACKGROUND

This disclosure relates generally to monitoring building construction.

During construction of large complex construction projects, integrated comprehensive collaborative Quality Control processes are required to support regulatory agencies, owner construction oversight, and general contractor oversight and subcontractor operations. In order to efficiently manage the construction process the general contractor and owner ideally would have up-to-the-minute status of every subcontractor, construction element, room and inspection. When information such as inspection, issue data and punch list data is delayed, the schedule impacts and associated costs accumulate.

### SUMMARY

In general, one innovative aspect of the subject matter described in this specification may be embodied in methods that include the actions of receiving an indication of a floor plan of a building project; receiving an indication of an inspection report, the inspection report associated with an inspection type; identifying a forecast date associated with each room in the floor plan, the forecast date indicating when an inspection type associated with the respective room is to be completed; for each room, determining how close each room's forecast date is to a present date, and if the room's forecast date is past the present date; generating a visual map of the floor plan; associating a color of each room in the floor plan based on the determining; and providing the visual map with the associated color of each room for display.

Another aspect can be embodiment in methods that include the actions of receiving a selection of a floor of a building project, receiving a selection of an inspection type associated with the building project, receiving a selection of a forecast report, wherein the forecast report displays each room of the floor of the building project in a color indicating how close each room's assigned forecast date is to a present date, displaying a floor plan associated with the floor and inspection report, wherein the floor plan includes rooms that are each colored based on how close each room's assigned forecast date is to the present date.

In accordance with another embodiment, a map of a building project is received, the map including a structure and one or more defined spaces within the structure. An indication of one or more tasks to be performed with respect to the one or more defined spaces is received. A visual map of the building project is generated. For each of the one or more tasks, a forecast date indicating one of a start date when the task is to be started and an end date when the task is to be completed is identified, a difference between a current date and the forecast date is determined, a status of the task is determined, a color is selected for a respective defined space on the visual map based on the difference and the status of the task, and the respective selected color is displayed in the respective defined space of the visual map.

Other embodiments of these aspects include corresponding systems, apparatus, and computer-readable medium storing software comprising instructions executable by one or more computers, which cause the computers to perform the actions of the methods.

Further embodiments, features, and advantages, as well as the structure and operation of the various embodiments are described in detail below with reference to accompanying drawings.

### BRIEF DESCRIPTION OF THE FIGURES

Embodiments are described with reference to the accompanying drawings. In the drawings, like reference numbers may indicate identical or functionally similar elements.

FIG. 1 illustrates a system for monitoring inspection.

FIG. 2 illustrates a display view of a floor plan.

FIG. 3 illustrates a display view of a floor plan.

FIG. 4 illustrates a display of a floor plan.

FIG. 5 illustrates a display of a key of a floor plan.

FIG. 6 illustrates a flowchart of an example process.

FIG. 7 illustrates an example user device including a browser.

FIG. 8 is a diagram of an example computer device used to implement the system.

FIG. 9 shows a map and scheduling management system in accordance with an embodiment.

FIG. 10 is a flowchart of a method of generating and displaying a schedule impact map in accordance with an embodiment.

FIG. 11 is a flowchart of a method of generating and displaying a schedule impact map in accordance with an embodiment.

FIG. 12 is a flowchart of a method of generating and displaying a schedule impact map in accordance with an embodiment.

FIG. 13 is a flowchart of a method of generating and displaying a schedule impact map in accordance with an embodiment.

FIG. 14 is a flowchart of a method of generating and displaying a schedule impact map in accordance with an embodiment.

FIG. 15 is a schedule impact map in accordance with an embodiment.

FIG. 16 is a count chart in accordance with an embodiment.

FIGS. 17A and 17B is a flowchart of a method of transforming representations of categories of products assigned to defined spaces within structures into visual maps encoded with color characteristics in accordance with an embodiment.

### DETAILED DESCRIPTION

A system will be described that provides indications of project milestones to users of the system who are using it in order to track status of building construction. The system is robust enough to enable the orchestration of complex professional organizations, streamlining their interactive processes in order to minimize task duration, down time and unnecessary delays.

In one implementation, an inspection monitoring process is provided that provides real-time collaboration, process tracking, quality control timing, and status reporting associated with a construction project. The process can include reporting that allows a user to visually see how far out a project is from completion for each milestone.

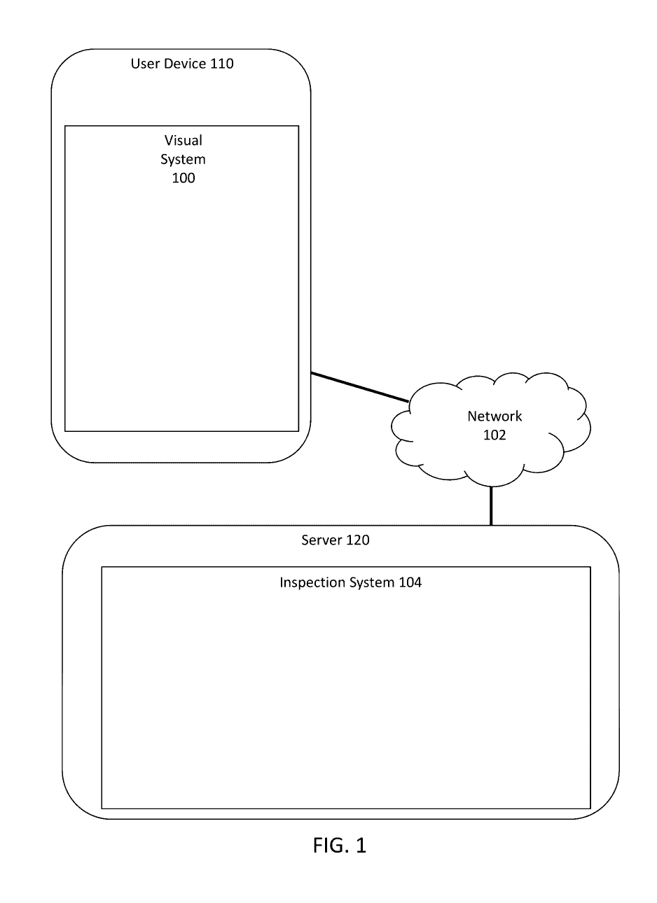

FIG. 1 illustrates an example of a networked system of devices, perhaps mobile devices such as mobile phones, tablets or computers. The devices may be networked over network 102. Network 102 may be any network or combination of networks that can carry data communications. Such a network 102 may include, but is not limited to, a local area network, metropolitan area network, and/or wide area network such as the Internet. Network 102 can support protocols and technology including, but not limited to, World Wide Web (or simply the “Web”), protocols such as a Hypertext Transfer Protocol (“HTTP”) protocols, and/or services. Intermediate web servers, gateways, or other servers may be provided between components of the system shown in FIG. 1, depending upon a particular application or environment.

A user may operate a user interface on user device 110 to track forecast dates of milestones for a construction project. The milestone data, forecast data, and other data used to track forecast dates may be stored, accessed, distributed or modified using a system stored on and executed by server 120

User device 110 may be coupled to server 120 over network 102. Server 120 includes inspection system 104, which may be used to provide information to user device 110.

Visual system 100 may be implemented on or implemented with one or more computing devices, such as user device 110.

Inspection system 104 allows users to be able to track the status of different phases of a construction process. System 104 allows visual fragnets to be created that shows on a visual display the different status of various parts of a project. A visual fragnet is an interactive floor plan of a level of a building. For example, visual fragnets can be created to show the status of an inspection for a particular milestone in a project. Visual fragnets can also be created to show forecast completion dates associated with various milestones in a project.

Inspection system 104 first creates the maps that will be used by the system. These maps can be room-based maps, or they can be section based, area based, or equipment based. Inspection system 104 receives architectural drawings that are 2d or 3d, and converts these drawings to a 2D room based map. For example, if the construction project is for a hospital, each level of the hospital is associated with an architectural drawing. These maps are imported into inspection system 104 and they are then converted into 2D room based maps. These room-based maps are used by inspection system 104 to track various milestones associated with the project.

Visual System 100 allows user to interact with Inspection system 104 through network 102.

Each construction project can be made up of various project milestones. Project milestones are parts of a construction project that in total make up the complete construction phase of the project. For example, milestones can be Steel Erection, Fireproofing, Exterior Skin, In Wall Completion. The term “Milestone” is relative to the group that is using it. For example, the framing subcontractor may consider “In Wall Framing” a milestone because it's their scope. On the other hand, the General contractor may view “In Wall Framing” as an Activity. For the purposes of the proximity report showing how far out the forecast date is, a “Milestone” is a large phase of work comprised of smaller activities. “Milestones” can be Steel Erection, Fireproofing, In Wall Completion, Overhead Completion, etc. Each milestone has different activities associated with it. The activities are the different inspection request that make up a milestone like In Wall Framing, In Wall Plumbing, etc. Visual Fragnet reports can be run based on individual “Activities”.

Milestones are set using standards by a general contractor or owner of a project. Milestone provides a sequence of inspection types that are organized and ordered to let the general contractor or owner know everything is done in a specific room or area prior to close-up. For example, the in wall milestone can include the following inspection types: framing inspection, electrical, and mechanical inspection.

In one embodiment, when a report such as a proximity report is run, it will show how far out each room is for that inspection type and the same can be done for a milestone that includes more than one inspection type. Therefore, when a report is run for a milestone that includes multiple inspections. For example, the in-wall milestone may include 3 or 4 different inspection types. The rooms can be colored based on an average date of how far out all the inspection types are together. In another embodiment, each room can have multiple indications of different inspection types so each inspection type is colored in the room. For example, one room can include 3 colors, 1 color for each inspection.

Once a project is underway, various subcontractors will work on various rooms to complete different tasks associated with a milestone. As each task or activity is completed, system 110 receives the updated status for each task. When every task associated with a milestone is completed, the room is marked for inspection in system 110. An inspector then will inspect the room for a specific inspection type. The inspection type is tied to the milestone. For example, if the milestone is electrical, an electrical inspection of the room is performed.

A status of “new” is automatically assigned when a subcontractor creates an inspection request. Status “open” is selected by the General Contractor when they believe the request is ready to go to the inspectors. A status of “closed” is assigned for completed rooms, or “issue” is assigned for rooms that have issues, or “rejected” is a status for those rooms not even close to being done. An inspection type of “not applicable” may be applied to some rooms. For example, some rooms wont have plumbing so those rooms for the inspection type plumbing are marked as not applicable.

System 104 stores these statuses associated with each milestone. One room can be associated with many milestones.

Inspection system 104 allows the users to assign a Forecast Complete date to a specific set of rooms for a project. Subsequently, depending on the map or visual fragnet report that is being used, the forecasted room will automatically update to a different color based on how far the forecasted date is from the current date. This allows the project managers or general contractors or other users to easily identify the areas in the building that require the most attention in order to meet the forecasted goal.

In one embodiment the colorization of the rooms is standardized based on the report that is being run. However, reports that are based on colorizing the rooms by forecasted dates are colorized randomly. This is because it may not be clear how many different forecasts are going to be used and are unable to decide which colors to use. It could happen that one floor plan will have 20 forecast dates for a single inspection type. Thus, the system assigns a random color to each date in that report.

A building has different areas and each area can be made up of one or more rooms. A user, for example a general contractor, pulls up map of the construction project on visual system 100, selects an inspection type like framing, and then highlights all areas in a certain area and adds a forecast date to those rooms specific to inspection type. The user does this for all the different inspection types. Inspection system 104 receives an indication of each of these selections and stores them.

System 104 stores the completion date associated with each room in the map. Therefore, each room is associated with a completion date for each milestone. For example, room A in a hospital floor plan may be associated with a completion date of Jun. 1, 2013 for its electrical inspection, and Jul. 1, 2013 for its mechanical inspection. The milestone is a combination of inspection types. In this scenario, we have a different date for electrical and a different date for mechanical. What this means is that in the milestone for the row with room X, it will display one date for the electrical column and a different date for the mechanical column.

A user can run a report such as a forecast and proximity report using system 104. This map or visual fragnet provides the user with a special colorization sequence based on how close the forecast date is to the current date. This allows the user to quickly identify all the rooms that are near their forecasted date so that they can mobilize additional resources in order to meet their deadline. Additionally, once the room has been inspected and approved, it will show up in the “Closed” status to show that it is completed.

The user, using visual system 100, can first select a floor of a building, then select an inspection type. For example, electrical inspection or plumbing inspection. A map is loaded by system 104 for the specific inspection type and the floor selected.

Once the visual fragnet has finished loading, the user can utilize a visual fragnet key that is displayed relative to the map to obtain the associated data and identify the number of rooms that are close to or past their forecast date. Furthermore, the ranges can be customized to meet the project needs and updated over time if desired.

This colorized map or visual fragnet provides the user with a special colorization sequence showing the user exactly what rooms are assigned to which “Forecast Date” and which rooms have yet to be assigned.

This colorized map or visual fragnet provides the user with a special colorization sequence based on the real time status of the rooms as well as a forecast date for the rooms that are not yet completed. The user can utilize this map to view a comprehensive visual representation of the current and expected future status of the work.

Implementations of visual system 100 may be provided through a mobile application stored in computer-readable media of user device 110 and executed by one or more processors on the device. The application can display a user interface that is operated by the user. In some implementations, inspection system 104 may provide the functionality of future location system 100. On other implementations, the functionality of systems 100 and 104 may be provided through a browser.

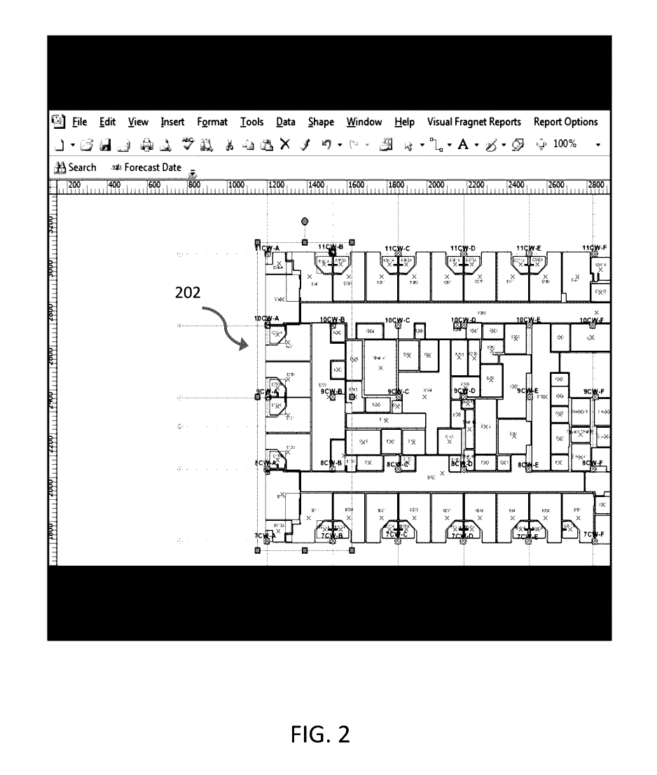

FIG. 2 is an example floor based map. The user first selects an inspection type and a level or map. The map in FIG. 2 may be a map of a hospital floor. As shown, none of the rooms are shaded they are all one color. The blank drawing means that there are currently no rooms with an assigned forecast date for that specific inspection. In order to assign a forecast date, the user will need to select the rooms, for example, rooms 202, you wish to update and then click on the “Forecast Date” button located in the upper left corner of the map. This will assign a forecast date to those rooms for the specific inspection selected. Once the user clicks on the “Forecast Date” button, a “Forecast Completion” screen appears. This screen provides the user with a list of all the rooms he/she has selected and will also show the user if those rooms have a “Custom Area” or a “Forecast Date” assigned to them.

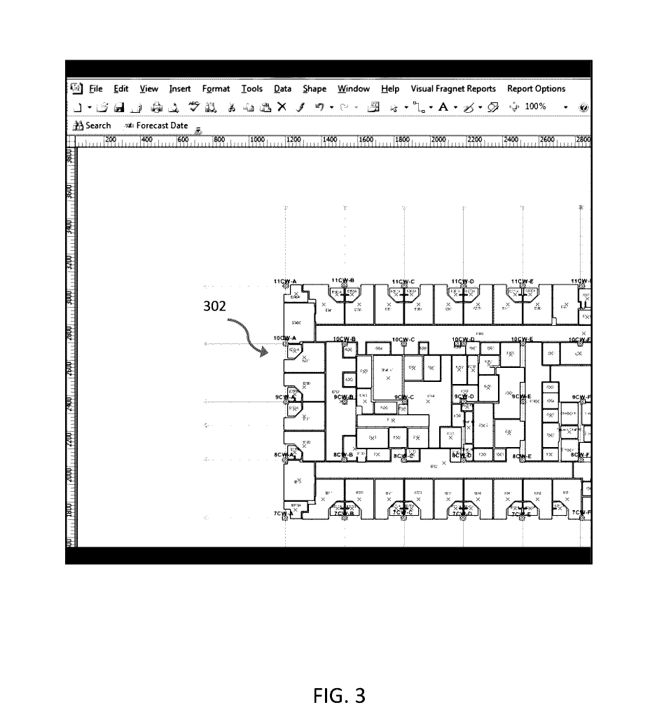

Having assigned a date to your selected rooms, the visual fragnet or colorized map will automatically reload in order to show the change. As shown in FIG. 3, the selected rooms 302 are now a different color which will signify something different depending on what report is being run. A user would have to look at the Key. Some colors are standardized and some colors are assigned randomly. Thus, one report may show the rooms in red, while another report may show them in purple. In this example, the rooms are colorized based on a proximity report which shows how far out each of the rooms are from a forecast date associated with an inspection type.

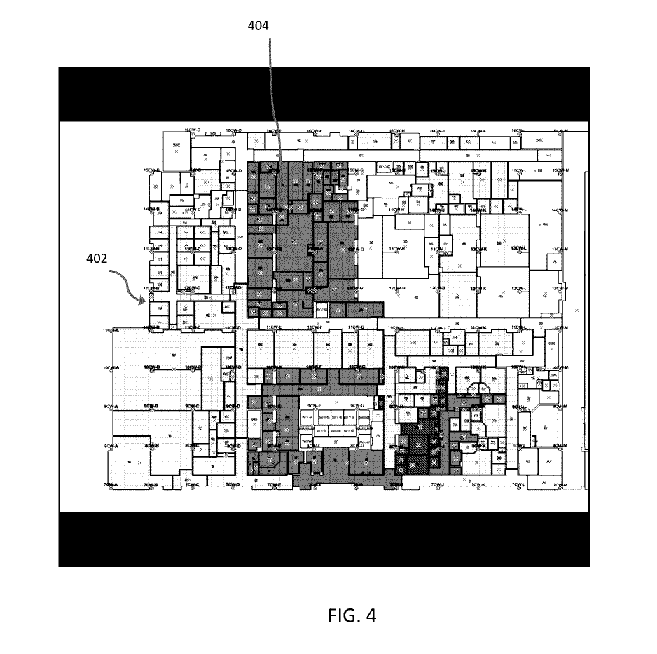

FIG. 4 is a colorized map or visual fragnet showing forecast and proximity based on a report that was run. This colorized map or visual fragnet provides the user with a special colorization sequence based on how close the forecast date is to the current date. This allows the user to quickly identify all the rooms that are near their forecasted date so that they can mobilize additional resources in order to meet their deadline. Additionally, once the room has been inspected and approved, it will show up in the “Closed” status to show that it is completed.

Once the visual fragnet has finished loading, the user can utilize the key to obtain the associated data and identify the number of rooms that are close to or past their forecast date. It can be visually seen that the rooms do not all have the same color or shading, because each set is a different number of days away from their forecast date. For example, the rooms 402 are a different shade or different color from rooms 404. This means each set of rooms is associated with a different forecast date for the inspection type selected, and therefore the color on the floor plan will be different since the color correlates to the number of days out each room or set of rooms are from the forecast date associated with the rooms for that inspection type.

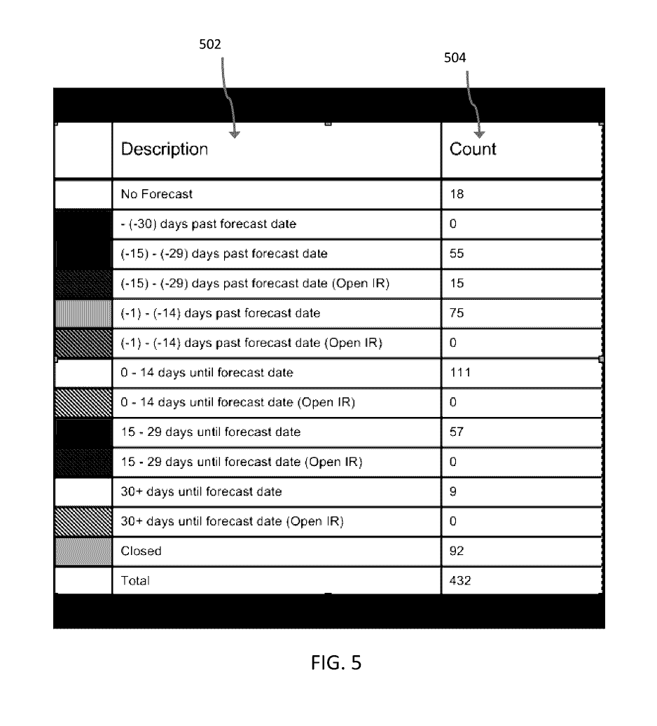

The key is shown in FIG. 5. Furthermore, the ranges can be customized to meet the project needs and updated over time if desired. The ranges in the FIG. 5 report can be changed depending on what the project wants. Some projects want to have ranges that are 10 days long and some want some that are 5 days long. (FIG. 5 shows 15-day ranges. These ranges can be customized by the user. A general description 502 is given for each color. For example, one color is selected for rooms that are less than 30 days past their forecast date, another one is chosen for rooms 30 days plus until their forecast date. Rooms or areas can be associated with forecast dates that are in the past. Therefore, if a forecast date is before the current date the number of days out is a negative number, because the current date is past its inspection date. These rooms are associated with forecast dates in the past.

In one embodiment, a count 405 is also shown for the number of rooms that are associated with the number of days out.

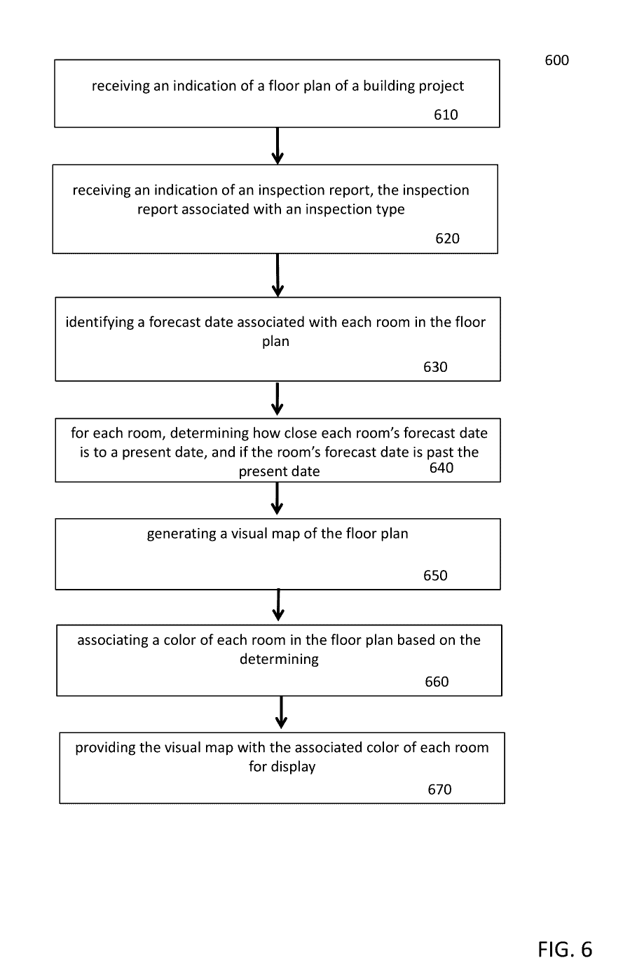

FIG. 6 illustrates a flowchart of an example process 600. The process may be implemented by inspection system 104 or visual system 100.

At stage 610, an indication of a floor plan of a building project is received. For example, inspection system 104 receives an indication of a floor plan of a building project is received. A building can include many different levels and a floor plan can be associated with each level.

At stage 620, an indication of an inspection report is received. The inspection report can be associated with an inspection type. For example, inspection system 104 receives an indication of an inspection report. An inspection type can be associated with a construction phase of the project. Examples of inspection types can include electrical, mechanical, plumbing, drywall etc.

At stage 630, a forecast date associated with each room in the floor plan is identified. The forecast date can indicate when an inspection type associated with the respective room is to be completed. For example, inspection system 104 identifies a forecast date associated with each room in the floor plan. The forecast date is set by the user. The user decides when they need the inspection type for the room completed. The user, can for example, be a general contractor of a project. The forecast date can be a date in the future. In one embodiment, the forecast date can be a number of days out from the current date. For example, the user can set the forecast date of the electrical inspection as 30 days out from the current date instead of selecting an actual date. Inspection system 104 can calculate the date that 30 days would fall on.

At stage 640, for each room, a determination is made of how close each room's forecast date is to a present date, and if the room's forecast date is past the present date. For example, inspection system 104 determines how close each room's forecast date is to a present date, and if the room's forecast date is past the present date. Inspection system 104 can compare the current date to the forecast date of the inspection type. The number of days in between the two dates can be calculated and inspection system 104 can determine how many days out each forecast date is for a specific inspection type. For example, if the current date is Mar. 12, 2013, and the electrical inspection has a forecast date of Jul. 12, 2013, inspection system 104 can calculate that the electrical inspection is 120 days out.

At stage 650, a visual map of the floor plan is generated. For example, inspection system 104 generates the visual map of the floor plan. The visual map displays the rooms of the floor plan. Initially each room and each area in the floor plan can be a single color, for example, white. Each room is part of an area that is associated with a forecast date for each inspection type. An area can include one or more rooms. In one embodiment, each room is associated with a forecast date for each inspection type.

At stage 660, a color is associated with each room in the floor plan based on the determining. For example, inspection system 104 associated a color with each room in the floor plan based on the determining. Inspection 104 can associate a color for various ranges of dates. For example if a room is less than 5 days out from the forecast date, the color can be red, if a room is 30 days out from a forecast date the room can be green, if a room is 90 days out the room can be blue etc.

In one embodiment, inspection system 104 can use the same color but as the number of days get less, the color can become a darker version of one color. In the same example as above, if a room is less than 5 days out from the forecast date, the color can be dark red, if a room is 30 days out from a forecast date the room can be a regular red color lighter than the dark red, if a room is 90 days out the room can be pink, so a lighter version of the range above this one.

At stage 670, the visual map with the associated color of each room is provided for display. For example, inspection system 104 provides for display the visual map with the associated colors. The map can include the range or ranges and the color associated with each. For example, the map (or key) can include: less than 5 days and show a dark red color next to it, or show a regular red and show 30 days out, and show a pink and show more than 90 days out.

In one embodiment, the user can change the forecast dates of each inspection type. As the user changes the dates, the colors on the map will dynamically change. The forecast dates can be changed to be closer to the present date or farther from the present date. When a report is run for a specific inspection type, and the dates are changed, the user can see the new colors on the map based on how far out each room or area is now with the new forecast dates.

In one embodiment, a method can include receiving a selection of a floor of a building project. The selection can be received from a user device. A user may be using the user device and select a floor of a building project from a given number of floors. Each floor has a floor plan associated with it.

The method can also include receiving a selection of an inspection type associated with the building project. The user can be presented with a number of different inspection types to choose. In one embodiment, the user can type in a specific inspection type. Inspection system 104 receives the selection of the floor and the inspection type.

The method can further include receiving a selection of a forecast report, wherein the forecast report displays each room of the floor of the building project in a color indicating how close each room's assigned forecast date is to a present date.

The method can further include displaying a floor plan associated with the floor and inspection report, wherein the floor plan includes rooms that are each colored based on how close each room's assigned forecast date is to the present date. Inspection system can determine if each room in the floor plan is associated with a forecast date for the selected inspection type. Then inspection system 104 can calculate how far out each forecast date is from the current date. Inspection system 104 can generate a floor plan of colored rooms based on how far out each room is. Each room can be associated with the inspection type selected and also be associated with its own forecast date as selected by a user, for example, the general contractor. The floor plan is displayed on a display device showing each room colored according to a map or a key displayed with the floor plan.

In an embodiment, the functionality of 100 and/or system 104 may be provided through a browser on computing devices, such as user device 110. Inspection system 104 on server 120 may host the service and serve it to device 110 and any other computing devices. Any combination of implementations may provide, through a browser, the functionality represented by the example implementations of systems 100 and 104 shown in FIG. 1 and in the display views and flowchart of FIGS. 2-6. Any stages shown in flowchart 600 that involve displaying content may be considered to provide the content for display in a browser.

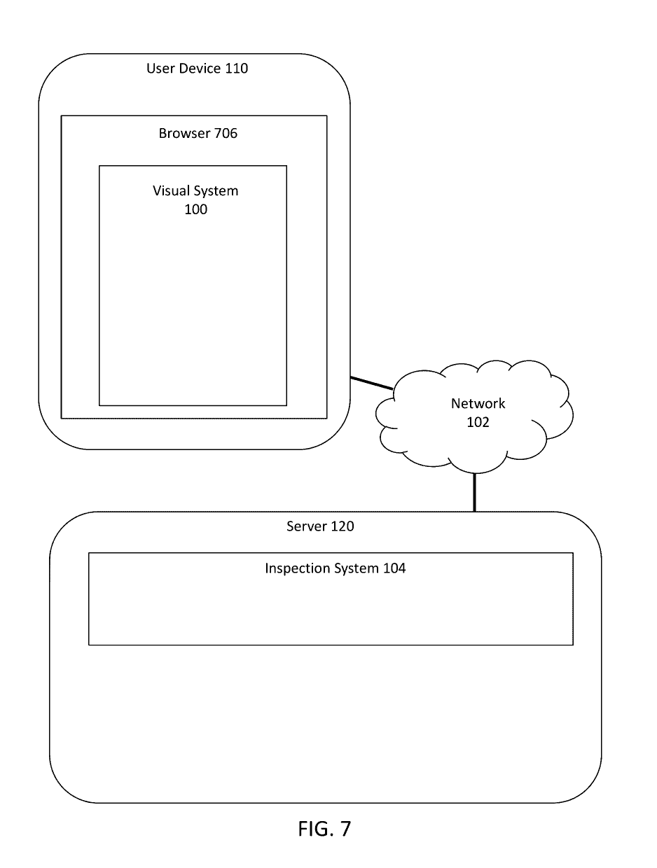

For example, FIG. 7 shows user device 110 executing browser 702. Browser 702 may be any commonly used browser, including any multi-threaded or multi-process browser. In an embodiment, the functionality of visual system 100 can be provided through browser 702. Future dates are received or displayed in browser 702.

The functionality of any of the components or flowcharts shown in FIGS. 1-6 may be provided through a browser executed on device 110, server 120 or any other computing device. The web pages or application provided through the browser may be served from server 120, device 110, or any other computing device. Different windows or views may be shown through browser 702. Different permissions or filters may be established based on the identity or roles of the individual logging into a website view.

System 100 and 104 may be software, firmware, or hardware or any combination thereof in a computing device. A computing device can be any type of computing device having one or more processors. For example, a computing device can be a computer, server, workstation, mobile device (e.g., a mobile phone, personal digital assistant, navigation device, tablet, laptop, or any other user carried device), game console, set-top box, kiosk, embedded system or other device having at least one processor and memory. A computing device may include a communication port or I/O device for communicating over wired or wireless communication link(s).

Computing devices such as a monitor, all-in-one computer, smart phone, tablet computer, remote control, etc., may include a touch screen display that accepts user input via touching operations performed by a user's fingers or other instrument. For example purposes, a touch sensor grid may overlay the display area. The touch sensor grid contains many touch sensitive areas or cells that may be used to locate the area closest to the input of a user's touch.

Example touch operations using a touch screen display may include (but are not limited to) pinching, finger (or other stylus or object) touches, finger releases, and finger slides. Finger slides may be circular or any other shape, direction or pattern. The touch screen display may include a screen or monitor that may render text and/or images.

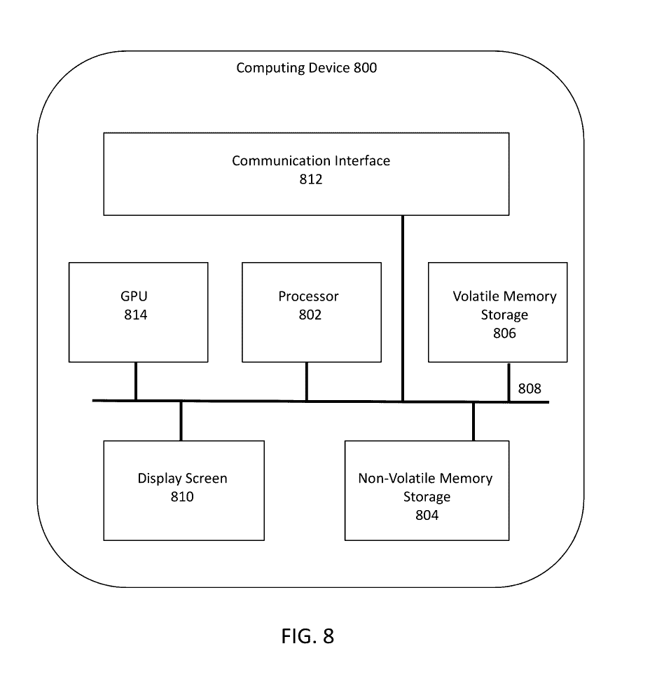

FIG. 8 is an example computer system 800 in which embodiments of the present invention, or portions thereof, may be implemented as computer-readable code. For example, the components of systems 100 and 104 may be implemented in one or more computer systems 800 using hardware, software implemented with hardware, firmware, tangible computer-readable media having instructions stored thereon, or a combination thereof and may be implemented in one or more computer systems or other processing systems. Components in FIGS. 1-7 may be embodied in any combination of hardware and software.

Computing devices, such as devices 110 or server 120, may include one or more processors 802, one or more non-volatile storage mediums 804, one or more memory devices 806, a communication infrastructure 808, a display screen 810 and a communication interface 812.

Processors 802 may include any conventional or special purpose processor, including, but not limited to, digital signal processor (DSP), field programmable gate array (FPGA), application specific integrated circuit (ASIC), and multi-core processors.

GPU 814 is a specialized processor that executes instructions and programs, selected for complex graphics and mathematical operations, in parallel.

Non-volatile storage 804 may include one or more of a hard disk drive, flash memory, and like devices that may store computer program instructions and data on computer-readable media. One or more of non-volatile storage device 904 may be a removable storage device.

Memory devices 806 may include one or more volatile memory devices such as but not limited to, random access memory. Communication infrastructure 808 may include one or more device interconnection buses such as Ethernet, Peripheral Component Interconnect (PCI), and the like.

Typically, computer instructions are executed using one or more processors 802 and can be stored in non-volatile storage medium 804 or memory devices 806.

Display screen 810 allows results of the computer operations to be displayed to a user or an application developer.

Communication interface 812 allows software and data to be transferred between computer system 800 and external devices. Communication interface 812 may include a modem, a network interface (such as an Ethernet card), a communications port, a PCMCIA slot and card, or the like. Software and data transferred via communication interface 812 may be in the form of signals, which may be electronic, electromagnetic, optical, or other signals capable of being received by communication interface 812. These signals may be provided to communication interface 812 via a communications path. The communications path carries signals and may be implemented using wire or cable, fiber optics, a phone line, a cellular phone link, an RF link or other communications channels.

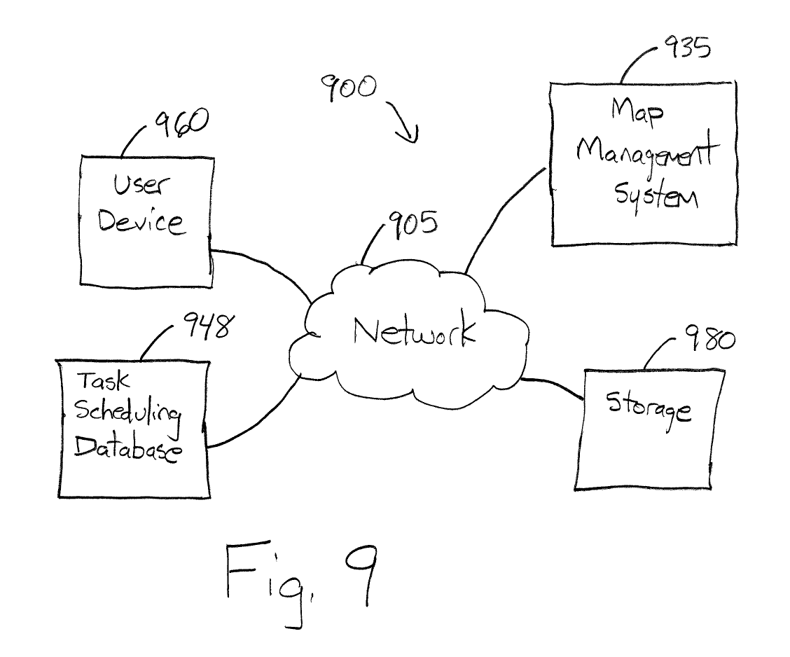

In accordance with another embodiment, a map and scheduling management system is provided. FIG. 9 shows a map and scheduling management system in accordance with an embodiment. Map and scheduling management system 900 includes a network 905, a map management system 935, a task scheduling database 948, a user device 960, and a storage 980.

Network 905 may be any network or combination of networks that can carry data communications. Such a network 905 may include, but is not limited to, a local area network, metropolitan area network, and/or wide area network such as the Internet. Network 905 can support protocols and technology including, but not limited to, World Wide Web (or simply the “Web”), protocols such as a Hypertext Transfer Protocol (“HTTP”) and HTTPS protocols, and/or services. Intermediate web servers, gateways, or other servers may be provided between components of the system shown in FIG. 9, depending upon a particular application or environment.

Task scheduling database 948 stores information related to various tasks and schedules. For example, task scheduling database 948 may store tasks and schedules related to a construction project. Such tasks and schedules may be used in project management for a particular construction project, for example.

Map management system 935 generates maps related to a construction project. For example, map management system 935 may generate a map showing rooms and defined spaces in a building that is under construction. Map management system 935 may generate a map of a building project that indicates additional information for each room or defined space in the building, for example, by adding selected colors to various portions of the map. Map management system 935 may retrieve stored maps, for example, from storage 980, In an embodiment, one or more of the defined spaces have a corresponding space identifier, this identifier improving the way information about the defined spaces is stored, retrieved and combined with other information.

Storage 980 stores data. For example, storage 980 may store one or more maps related to a building project.

User device 960 is a processing device that allows a user to access map management system 935 via network 905. For example, user device 960 may be a personal computer, a laptop computer, a cell phone, a smart phone, a tablet computer device, or other type of processing device.

In various embodiments, systems and methods described herein may be used to enable a user to generate map reports that visually represent the statuses of tasks associated with individual spaces within the map in relation to the target task end date vs. current date or actual end date for a given task or milestone tracked by the system. The system adds colors to individual spaces on a map based on the duration of time between the target completion date of the task/milestone being tracked and the current date or the actual completion date of the task. All spaces on the map that have durations that fall within a first time frame are represented on the map with the same (first) color, spaces with durations that fall within a second (different) time frame are shown on the map with a second color, etc. Each predetermined time frame is associated with a unique color.

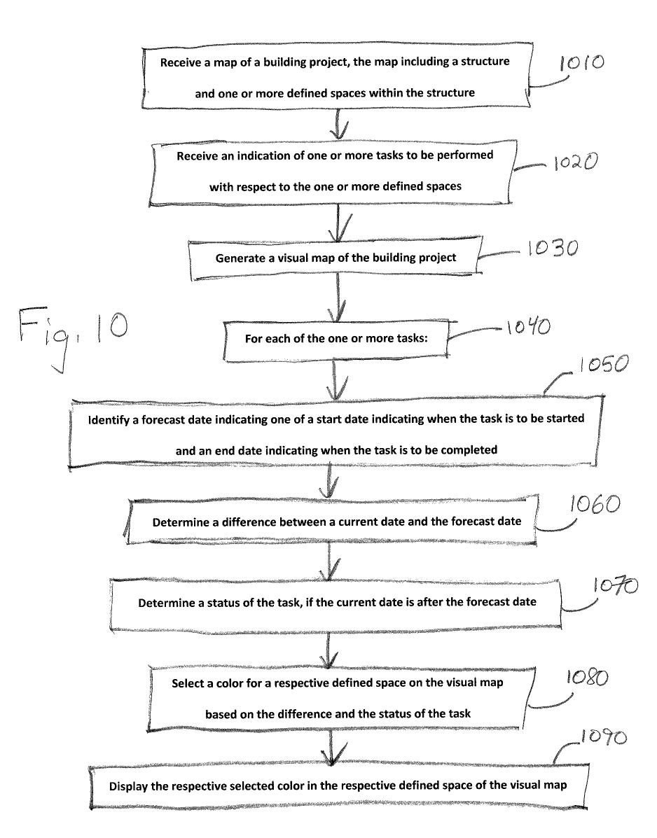

In accordance with an embodiment, system 900 may be used to generate a map showing progress on various tasks in a building project. FIG. 10 is a flowchart of a method of providing a map showing progress on various tasks in a building project in accordance with an embodiment.

At step 1010, a map of a building project is received, the map including a structure and one or more defined spaces within the structure. For example, map management system 935 may retrieve a map of a building project from storage 980. The map may include rooms or other defined spaces, as in the map shown in FIG. 2. The map retrieved from storage 980 may be in any format; for example, map management system 935 may retrieve data representing a map.

At step 1020, an indication of one or more tasks to be performed with respect to the one or more defined spaces is received. Map management system 935 retrieves from task scheduling database 948 a list of tasks related to the building project and a schedule for completion of the tasks.

At step 1030, a visual map of the building project is generated. Map management system 935 generates a map similar to the map shown in FIG. 2. If necessary, map management system 935 generates a visual map based on the information retrieved from storage.

Referring to block 1040, for each of the one or more tasks, a series of steps is performed. In the illustrative embodiment, steps 1050, 1060, 1070, 1080, and 1090 are performed for each task.

At step 1050, a forecast date indicating one of a start date when the task is to be started and an end date when the task is to be completed is identified. For example, in an illustrative embodiment, map management system 935 identifies a start date for the task.

At step 1060, a difference between a current date and the forecast date is determined. Map management system 935 determines if the start date is in the past or in the future, and determines how many days remain until the start date, or how many days have passed since the start date.

At step 1070, a status of the task is determined, if the current date is after the forecast date. In the illustrative embodiment, if the forecast date has not yet occurred, map management system 935 assign a status of “Not Started.” If the current date is after the forecast date (i.e., the forecast start date has already passed), map management system 935 assigns a status from one of the following statuses: “Not Started,” meaning that the task start date occurs in the future, “On Track,” meaning that the start date has already passed, and that the task work is in progress, “Escalated,” meaning that the start date has passed, the task work is in progress and additional resources are required in order to complete the work by the scheduled end date, or that the task end date has passed and the status has not been changed to “Closed,” and “Closed,” meaning that the task has been completed.

At step 1080, a color is selected for a respective defined space on the visual map based on the difference and the status of the task. In a manner similar to that described above, map management system 935 selects a color for the respective room or defined space based on the status of the task associated with the defined space or room. In the illustrative embodiment, map management system 935 selects a first color if the status of the task is “Not Started,” a second color if the status is “On Track,” a third color if the status is “Escalated,” or a fourth color if the status is “Closed.” The selected color is associated with the respective room or defined space of the structure that is associated with the task.

At step 1090, the respective selected color is displayed in the respective defined space of the visual map. Map management system 935 causes a visual map showing the various rooms and defined spaces, and the color associated with each room or defined space, to be displayed on user device 960. For example, map management system 935 may generate a web page that includes the visual map, and allow user device 960 to access the web page.

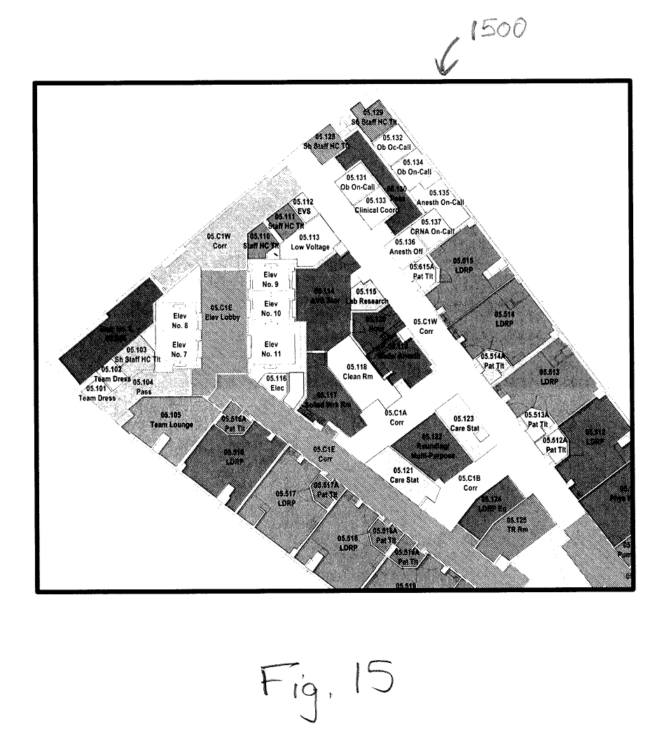

For example, map management 935 may display a map such as that shown in FIG. 15. FIG. 15 shows an example of a schedule impact map 1500 in accordance with an embodiment. Various rooms and defined spaces, and respective colors associated with each room or defined space, are displayed on map 1500.

In various embodiments, systems and methods described herein may be used to track the status of any type of task. For example, dates pertaining to tasks and milestones that may be tracked include: Project Kick-Off, Committee Kick-Off, Workflow/Validation Kick-Off, Workflow/Validation Complete, Building Turnover, Temporary Occupancy, Policies & Procedures Complete, Final Occupancy, Superuser Training Complete, Mock Licensure, Licensure, Activation/Day 1 Operations, Project Handoff to Operations, etc.

Tasks may be linked to milestones, one to determine the task's start date, and another to determine the task's target end date. Map management system 935 may generate start and end dates using milestone dates entered by a user. Actual task completion dates are captured by the system when a task status is changed to “Closed.”

Systems and methods described herein advantageously may generate schedule impact maps that display how close to a predetermined end date tasks assigned rooms are to the current date or the date that the task was intended to close. The system may display the status by showing the rooms to which the task was assigned to in a particular color based on the duration of time between the target end date and the current date or actual end date.

In accordance with another embodiment, dates pertaining to activities and milestones may be tracked include: target inspection date vs. actual inspection date, target milestone completion dates & target milestone report dates.

For example, the system may be able to generate schedule impact maps that display the status of how close a predetermined “target inspection date” for a scope of work assigned to a room is to the current date or the date that the inspection was actually completed. The system displays the status by showing the room to which the work was assigned to in a particular color based on the duration of time between the target inspection date and the current date or actual inspection date. The color and it's associated duration are displayed in a legend.

In another embodiment, the system gives users the ability to assign “Milestone Completion Dates” to high level construction milestones. The system displays a number of construction dates remaining for each of the construction milestones by showing the difference between the assigned milestone completion date and the current date. A corresponding color and the associated duration are displayed are displayed in a legend.

In another embodiment, the system milestone inspection reports are defined by a user and contain a specific set of inspection types. A milestone report is then able to display the status of each inspection in a sequential spreadsheet format (e.g., Excel) that allows the project team to verify that all required inspections took place in a specified room/section of the building. For rooms/sections without an inspection request, the milestone report displays a “Target Milestone Report Date” as defined by the project team for each of the selected inspection types.

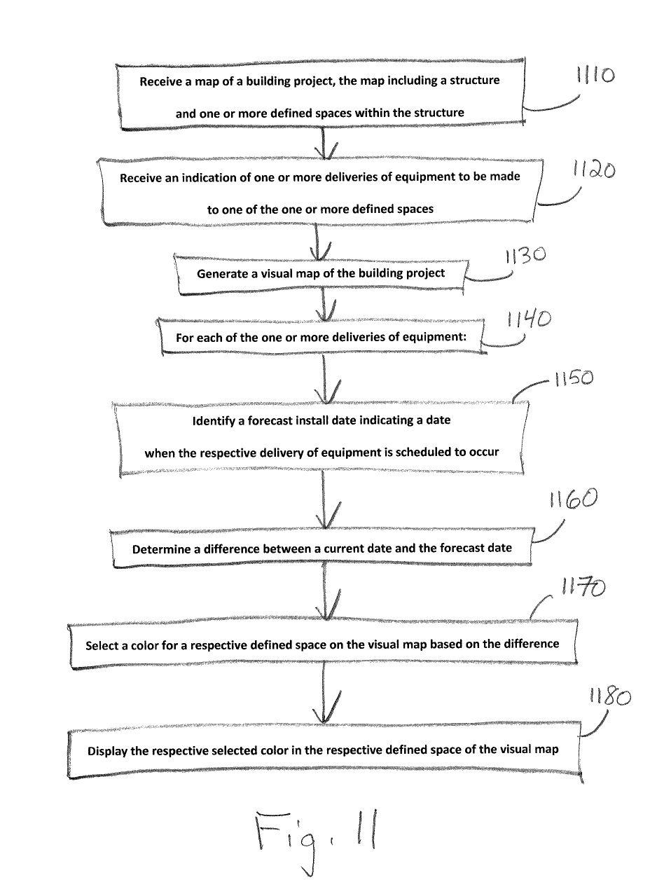

In accordance with another embodiment, system 900 may be used to generate a map showing progress on various activities related to a building project. For example, a map showing progress on deliveries of equipment may be generated and displayed. FIG. 11 is a flowchart of a method of providing a map showing progress on deliveries of items of equipment in a building project in accordance with an embodiment.

At step 1110, a map of a building project is received, the map including a structure and one or more defined spaces within the structure. In the illustrative embodiment, map management system 935 retrieves a map of a building project from storage 980.

At step 1120, an indication of one or more deliveries of equipment to be made to one of the one or more defined spaces is received. Map management system 935 may access a schedule of deliveries of different items of equipment; such schedule may be stored in storage 980, for example, or in task scheduling database 948.

At step 1130, a visual map of the building project is generated. Map management system 935 may retrieve a map of the building project from storage 980. Alternatively, map management system 935 may retrieve date representing a map and generate a map of the building project based on the information.

Referring to block 1140, a series of steps is performed for each of the one or more deliveries of equipment. In the illustrative embodiment, steps 1150, 1160, 1170, and 1180 are performed.

At step 1150, a forecast install date indicating a date when the respective delivery of equipment is scheduled to occur is identified. Map management system 935 may access task scheduling database 948, for example, and identify a particular defined space (e.g., a room) on the map, a piece of equipment that is scheduled to be delivered and installed in the space, and a target date for delivery.

At step 1160, a difference between a current date and the forecast date is determined. Map management system 935 determines whether the forecast install date has passed (and how much time has elapsed since the forecast date) or is in the future (and how much time remains until the forecast date).

In one embodiment, map management system 935 may assign a status to the delivery, such as “Late,” “Complete”, “Tomorrow,” “Within 2-3 Days,” “Within 4-10 Days,” “More Than 10 Days.”

At step 1170, a color is selected for a respective defined space on the visual map based on the difference. Map management system 935 assigns a color to each space on the map that has a scheduled delivery based on the difference between the current date and the forecast delivery date. In an illustrative embodiment, map management system 935 may assign yellow to all spaces in which a delivery has the status “Late,” red to all space in which a delivery has the status “Tomorrow,” “green to all spaces in which a delivery has the status “Within 2-3 Days,” etc.

At step 1180, the respective selected color is displayed in the respective defined space of the visual map. Map management system 935 causes the visual map to be displayed on user device 960 with the respective colors displayed in the corresponding defined spaces and rooms. In this manner, the user may quickly and easily see and identify the status of each delivery scheduled to be made in the building project.

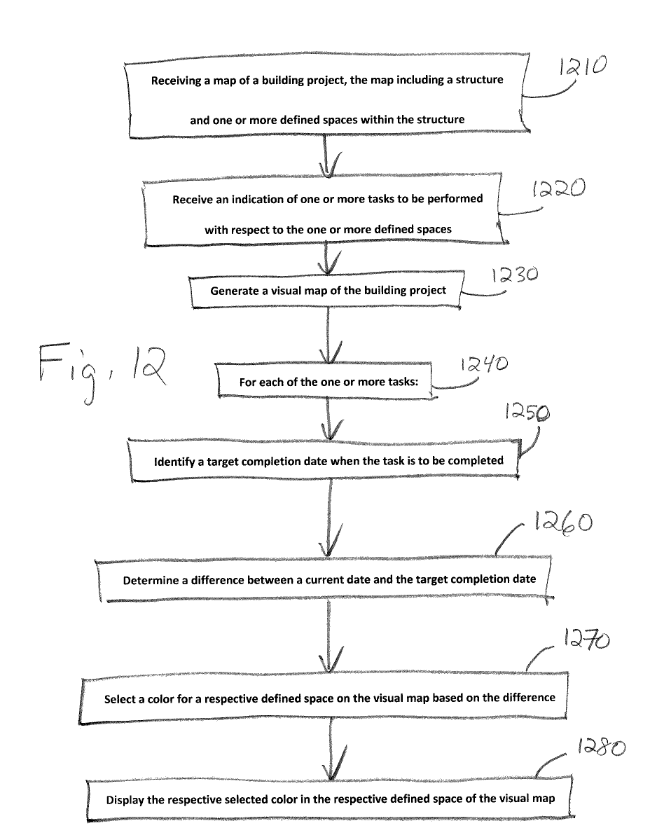

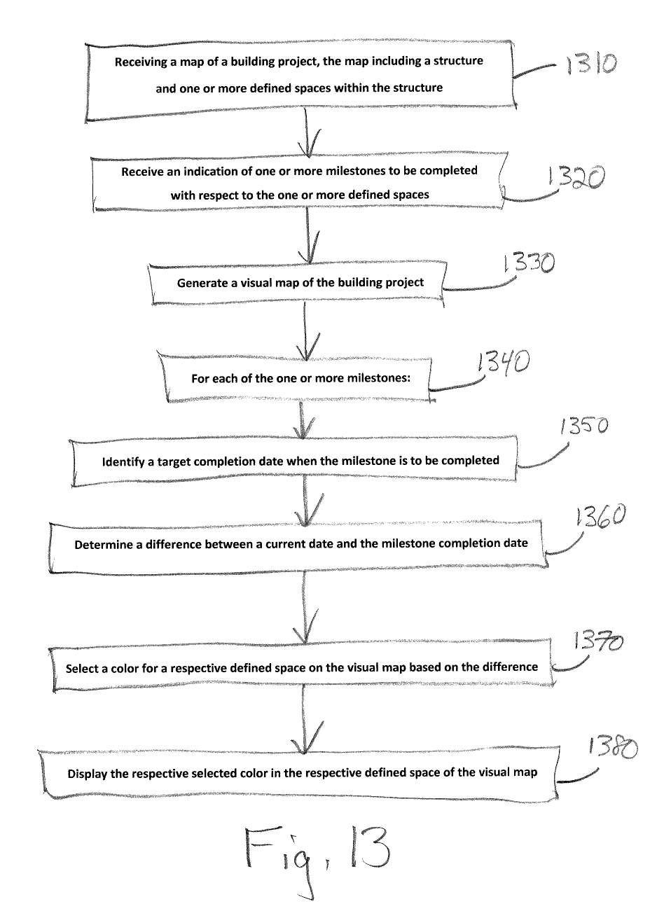

In accordance with another embodiment, system 900 may be used to generate a map showing progress on various tasks in a building project. Tasks may include activities or milestones. FIG. 12 is a flowchart of a method of providing a map showing progress on various tasks in a building project in accordance with an embodiment.

At step 1210, a map of a building project is received, the map including a structure and one or more defined spaces within the structure. For example, map management system 935 may obtain a map from storage 980.

At step 1220, an indication of one or more tasks to be performed with respect to the one or more defined spaces is received. In an illustrative embodiment, map management system 935 retrieves from task scheduling database 948 a list of one or more tasks to be performed and a schedule indicating when the tasks are to be performed.

At step 1230, a visual map of the building project is generated. Map management system 935 generates a map of a building that is under construction in connection with a building project. Map management system 935 may retrieve a map from storage 980.

At step 1240, a series of steps is performed for each of the one or more tasks. In the illustrative embodiment, steps 1250, 1260, 1270, and 1280 are performed.

At step 1250, a target completion date indicating when the task is to be completed is identified. Map management system 935 identifies a particular task associated with a particular room or defined space in the building, and a target completion date of the task.

At step 1260, a difference between a current date and the target completion date is determined. Map management system 935 determines a difference between the current date and the target completion date. Map management system 935 may determine a status of the task based on the difference.

At step 1270, a color is selected for a respective defined space on the visual map based on the difference. Map management system 935 selects a color associated with the difference and/or the status of the task, in a manner similar to that described above.

At step 1280, the respective selected color is displayed in the respective defined space of the visual map. Map management system 935 causes user device to display a map of the building that shows various defined spaces and rooms and in which each defined space and room is colored with the respective selected color corresponding to the status of the task associated with the space.

In accordance with another embodiment, system 900 may be used to generate a map showing progress on various milestones in a building project. Milestones may include activities or milestones. FIG. 12 is a flowchart of a method of providing a map showing progress on various milestones in a building project in accordance with an embodiment.

At step 1310, a map of a building project is received, the map including a structure and one or more defined spaces within the structure. For example, map management system 935 may obtain a map from storage 980.

At step 1320, an indication of one or more milestones to be performed with respect to the one or more defined spaces is received. In an illustrative embodiment, map management system 935 retrieves from task scheduling database 948 a list of one or more milestones to be performed and a schedule indicating when the milestones are to be performed.

At step 1330, a visual map of the building project is generated. Map management system 935 generates a map of a building that is under construction in connection with a building project. Map management system 935 may retrieve a map from storage 980.

At step 1340, a series of steps is performed for each of the one or more milestones. In the illustrative embodiment, steps 1350, 1360, 1370, and 1380 are performed.

At step 1350, a target completion date indicating when the milestone is to be completed is identified. Map management system 935 identifies a particular milestone associated with a particular room or defined space in the building, and a target completion date of the milestone.

At step 1360, a difference between a current date and the target completion date is determined. Map management system 935 determines a difference between the current date and the target completion date. Map management system 935 may determine a status of the milestone based on the difference.

At step 1370, a color is selected for a respective defined space on the visual map based on the difference. Map management system 935 selects a color associated with the difference and/or the status of the milestone, in a manner similar to that described above.

At step 1380, the respective selected color is displayed in the respective defined space of the visual map. Map management system 935 causes user device to display a map of the building that shows various defined spaces and rooms and in which each defined space and room is colored with the respective selected color corresponding to the status of the milestone associated with the space.

In one embodiment, dates pertaining to activities and milestones that may be tracked include: Target Install Date, Target Requested to be Delivered Date, Planned Delivered to Warehouse Date, Target Purchase Date, Target Validated Date, Target Pre-Install Complete Date, Target Fitup Complete Date, Target Ready for Owner Acceptance Date, and Target Room Complete Date.

In another embodiment, the system may generate schedule impact maps that display the status of how close a predetermined “Target install date” for a piece of equipment assigned to a room is to the current date or the date that the equipment was actually installed. The system displays the status by showing the room to which the product is assigned to in a particular color based on the duration of time between the target install date and the current date or actual install date. The color and the duration are also displayed in a legend.

In another embodiment, the system may generate schedule impact maps that display the status of how close a predetermined “target requested to be delivered date” for a piece of equipment assigned to a room is to the current date, or the date that the equipment was actually delivered. The system displays the status by showing the room to which the product is assigned to in a particular color based on the duration of time between the target requested to be delivered date and the current date or actual delivery date. The color and the associated duration are displayed in a legend.

In another embodiment, the system may generate schedule impact maps that display the status of how close a predetermined “Planned Delivered to Warehouse” for a piece of equipment assigned to a room is to the current date or the date that the equipment was actually delivered to the warehouse. The system displays the status by showing the room to which the product is assigned to in a particular color based on the duration of time between the planned delivered to warehouse date and the current date or actual delivered to warehouse date. The color and the associated duration are displayed in a legend. In an embodiment, one or more products have a corresponding product identifier, this identifier improving the way information about products is stored, retrieved and combined with other information.

In another embodiment, the system may generate schedule impact maps that display the status of how close a predetermined target purchase date for a piece of equipment assigned to a room is to the current date or the date that the equipment was actually delivered. The system displays the status by showing the room to which the product is assigned to in a particular color based on the duration of time between the target purchase date and the current date or actual purchase date. The color and the associated duration are displayed in a legend.

In another embodiment, the system may generate schedule impact maps that display the status of how close a predetermined “Target Validated Date” for a piece of equipment assigned to a room is to the current date or the date that the equipment was actually validated. The system displays the status by showing the room to which the product is assigned to in a particular color based on the duration of time between the target validated date and the current date or actual validated date. The color and the associated duration are displayed in a legend.

In another embodiment, the system may generate schedule impact maps that display the status of how close a predetermined “Target Pre-Install Complete” milestone date for a room is to the current date or the date that room actually completed the “Pre-Install Complete” milestone. The system displays the status by showing the room to which the product is assigned to in a particular color based on the duration of time between the “Target Pre-Install Complete” milestone date and the current date or actual Pre-Install Complete date. The color and the associated duration are displayed in a legend.

In another embodiment, the system may generate schedule impact maps that display the status of how close a predetermined “Target FitUp Complete” milestone date for a room is to the current date or the date that room actually completed the “FitUp Complete” milestone. The system displays the status by showing the room to which the product is assigned to in a particular color based on the duration of time between the Target FitUp Complete” milestone date and the current date or actual FitUp Complete date. The color and the associated duration are displayed in a legend.

In another embodiment, the system may generate schedule impact maps that display the status of how close a predetermined “Target Ready for Owner Acceptance” milestone date for a room is to the current date or the date that room actually completed the “Target Ready for Owner Acceptance” milestone. The system displays the status by showing the room to which the product is assigned to in a particular color based on the duration of time between the “Target Ready for Owner Acceptance” milestone date and the current date or actual Ready for Owner Acceptance date. The color and the associated duration are displayed in a legend.

In another embodiment, the system may generate schedule impact maps that display the status of how close a predetermined “Target Room Complete” milestone date for a room is to the current date or the date that room actually completed the “Room Complete” milestone. The system displays the status by showing the room to which the product is assigned to in a particular color based on the duration of time between the “Target Room Complete” milestone date and the current date or actual Room Complete date. The color and the associated duration are displayed in a legend.

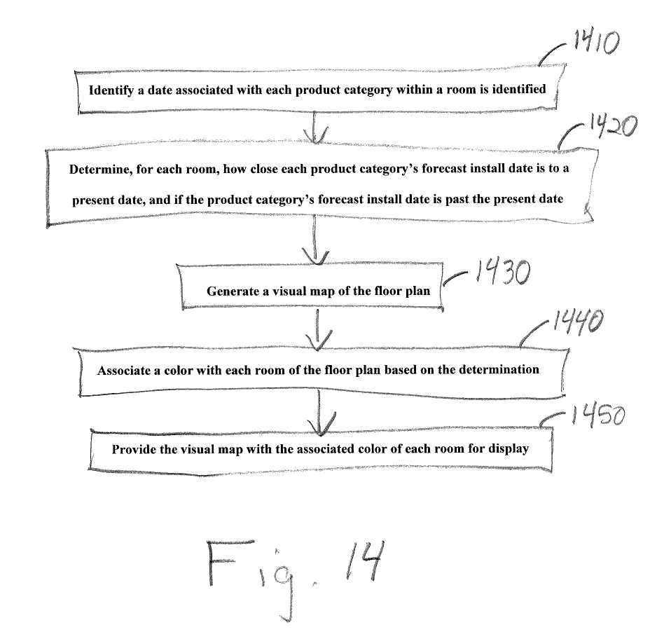

FIG. 14 is a flowchart of a method of providing a visual map in accordance with an embodiment. At step 1410, a date associated with each product category within a room is identified. At step 1420, for each room, a determination is made as to how close each product category's forecast install date is to a present date, and if the product category's forecast install date is past the present date. At step 1430, a visual map of the floor plan is generated. At step 1440, a color is associated with each room of the floor plan based on the determination. At step 1450, the visual map with the associated color of each room is provided for display. Systems and methods described herein may be used to implement the steps of FIG. 14.

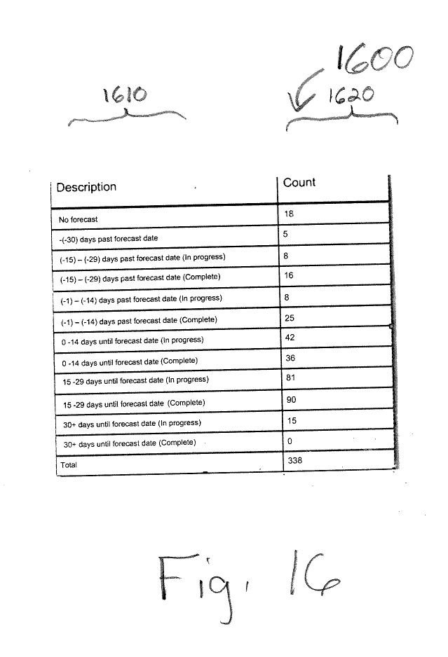

In accordance with another embodiment, map management system 935 may display on user device 960 information indicating how many spaces/rooms are associated with each of the possible statuses. FIG. 16 is a count chart in accordance with an embodiment. Count chart 1600 includes a first column 1610 that indicates various status (no forecast, 30 days past forecast date, 15-29 days past forecast date, etc.), and a second column 1620 showing a count indicating how many spaces/rooms have the respective status.

While in several illustrative embodiments, data relating to maps, tasks, milestones, and schedules are stored in one or more databases, in other embodiments, data related to maps, tasks, milestones, and schedules may be stored in other forms. For example, in another embodiment, map objects, task objects, milestone objects, and/or schedule objects may be used to organize and store data. For example, a map object store, a task object store, a milestone object store and/or a schedule data store may be created in storage 980 (or elsewhere) to store a plurality of map objects, task objects, milestone objects, and/or schedule objects, where, for example, each task object includes first data defining a task or activity that is to be completed, second data defining a location where the task is to be completed, and third data defining a schedule indicating when the task is to be completed. Similarly, a plurality of milestone objects may be created and stored in a milestone object store, where each milestone object stores data defining one or more tasks that are to be completed, locations where the tasks are to be completed, and a schedule for completing them. A map object may include a map, a plurality of tasks, a plurality of statuses, etc.

Thus, for example, in one embodiment, a system for managing tasks in a building project includes a processor, a memory communicatively coupled to the processor, and a task store, communicatively coupled to the processor, configured to store a plurality of task objects, each task object comprising first data defining a task to be completed, a location where the task is to be completed, and scheduling information indicating when the task is to be completed. The system also includes a map manager component communicatively coupled to the task store, the map manager component configured to receive information related to one or more tasks, and create and store a map object indicating a plurality of locations in the building and for each location a status of a corresponding task to be completed.

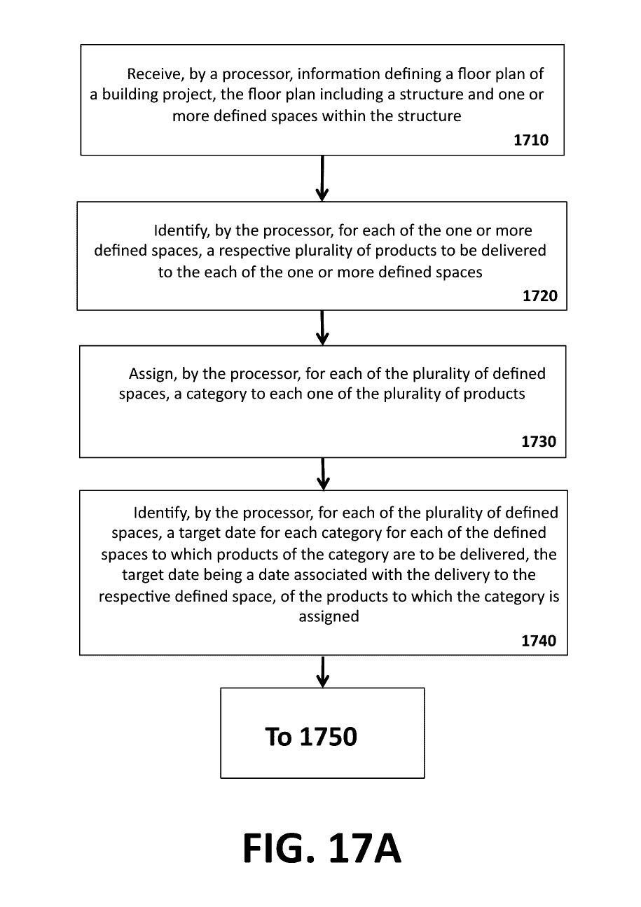

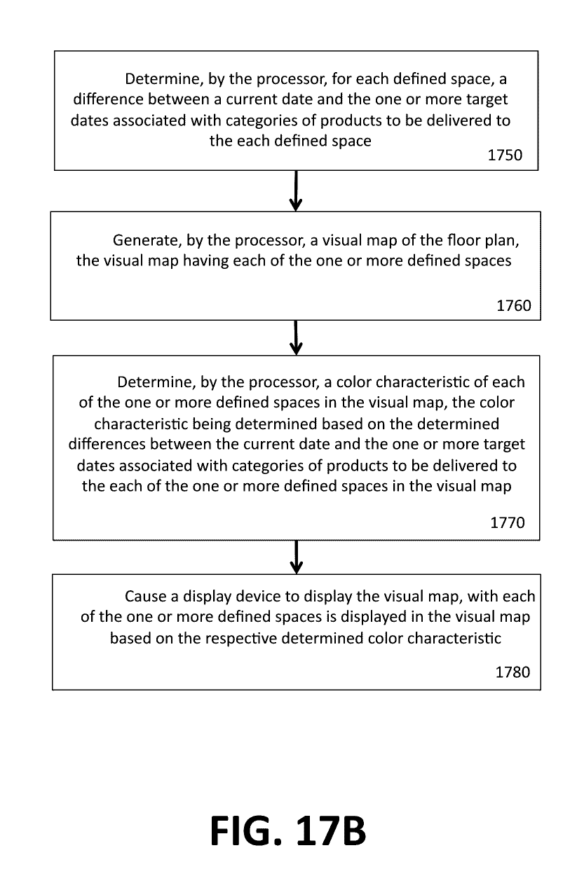

In accordance with another embodiment, system 900 may be used to generate a map showing information about products to be delivered to defined spaces (e.g., rooms) in a building. FIGS. 17A and 17B show a flowchart of a method of transforming representations of categories of products assigned to defined spaces within structures into visual maps encoded with color characteristics. For example, in an embodiment, server 120, operating inspection system 104, uses processor 802 in computing device 800. In an embodiment, the defined spaces within structures can be retrieved from storage 980, and the visual maps can be generated by map management system 935.

At step 1710, information defining a floor plan of a building project is received, the floor plan including a structure and one or more defined spaces within the structure. For example, information defining a floor plan (e.g., the floor plan of FIGS. 3 and 4) of a building project is received (e.g., at server 120 from storage 980), the floor plan including a structure and one or more defined spaces within the structure (e.g., as shows in FIGS. 3 and 4).

At step 1720, for each of the one or more defined spaces, products are identified to be delivered to the each of the one or more defined spaces. For example, task scheduling database 948 can store information about products to be delivered to the each of the one or more defined spaces.

At step 1730, for each of the plurality of defined spaces, a category is assigned to each one of the plurality of products. For example, server 120 can transmit a list of products to user device 960, and receive back assignments of categories to the products.

At step 1740, for each of the plurality of defined spaces, a target date is identified for each category for each of the defined spaces to which products of the category are to be delivered, the target date being a date associated with the delivery to the respective defined space, of the products to which the category is assigned. For example, server 120 can receive information from storage 980, task scheduling database 948, user device 960, and/or other sources, to identify target dates for the products to be delivered to different defined spaces in a building plan (e.g., FIGS. 3 and 4).

At step 1750, for each defined space, a difference is determined between a current date and the one or more target dates associated with categories of products to be delivered to each defined space. For example, server 120, can determine the difference between the current date and the target dates based on information stored in storage 980, and or received from user device 960.

At step 1760, a visual map of the floor plan is generated, the visual map having each of the one or more defined spaces. For example, server 120 can utilize map management system 935 (e.g., as a separate server, a component of hardware in server 120, or other implementation), to generate the visual map having the defined spaces.

At step 1770, a color characteristic of each of the one or more defined spaces in the visual map is determined, the color characteristic being determined based on the determined differences between the current date and the one or more target dates associated with categories of products to be delivered to the each of the one or more defined spaces in the visual map. For example, server 120 can use map management system 935 to select color characteristics (e.g., colors assigned to defined spaces, as in FIG. 4), based on the determined differences.

At step 1780, a display device displays the visual map, with each of the one or more defined spaces is displayed in the visual map based on the respective determined color characteristic. For example, server 120, operating using computer device 800 can use display screen 810 to display the visual map. In an additional example, the visual map can be displayed on user device 960 via network 905. In an example, each of the one or more defined spaces (e.g., in FIG. 4) is displayed in the visual map based on the respective determined color characteristic (e.g., color characteristics shows, for example in FIG. 4).

Embodiments also may be directed to computer program products comprising software stored on any computer-useable medium. Such software, when executed in one or more data processing device, causes a data processing device(s) to operate as described herein.

Embodiments of the invention employ any computer-useable or readable medium. Examples of computer-useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

Embodiments of the invention and all of the functional operations described in this specification may be implemented in digital electronic circuitry, or in computer software, firmware, or hardware, including the structures disclosed in this specification and their structural equivalents, or in combinations of one or more of them. Embodiments of the invention may be implemented as one or more computer program products, i.e., one or more modules of computer program instructions (e.g., processor instructions) encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus may include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

As described above, some embodiments herein can transform information describing a physical structure into a visual map displayed by a display. As would be appreciated by one having skill in the relevant art(s), in some implementations of embodiments, the information transformed, describing defined spaces within a physical structure can be significantly large, even in the context of powerful computers.

For example, as would be appreciated by one having skill in the relevant art(s), modern commercial real estate, e.g., office buildings, must incorporate a variety of different space types to meet the needs of staff and visitors. These may include: offices (private or semi-private), conference rooms, staff and visitor support spaces (convenience Store, vending machines), as well as lobbies, atria or common space: space, cafeterias/dining halls, private toilets or restrooms, child care centers, physical fitness area, interior or surface parking areas, administrative offices, storage food preparation spaces, computer server closets, and/or other similar defined spaces.

It would further be appreciated that the broad variety of different defined spaces in modern buildings requires a broad variety of different types of tasks, equipment, materials, milestones. Some embodiments described herein solve the problem of managing the construction of massive collections of defined spaces (e.g., buildings having large amounts rooms, and other types of rooms). It would be appreciated that time is of the essence when managing tasks, deliveries, forecasts, etc. associated with the construction of large buildings. In the industry, even minor reductions in time to perform management functions are sought after and valued by managers.

Moreover, even minor reductions in the amount of computer-time required to perform management functions (e.g., the collection, analysis, and presentation of information describing different defined spaces. Based at least on the discussion herein of the different processes used by some embodiments, one having skill in the relevant art(s) would appreciate that the processes described with embodiments results in a reduction in the amount of time needed to perform management functions, and further result in an increase in performance for a data processing apparatus that implements some embodiments described herein. Increases in performance and/or reduction of processing time will, in some embodiments, reduce the amount of power and/or other resources used by processing computers.

In an example of different combinations of feature discussed herein, by receiving floor plan data, and determining defined spaces within a building, embodiments reduce the amount of pre-processing required for floor plan data before it is transformed. In another example, the transformation, using determined forecasts, of defined spaces data into visual objects having determined color characteristics, improves the way that a computer performs computer-implemented construction management tasks.

Embodiments implemented using a data processing apparatus improve the operation of the data processing apparatus as compared to trying to manage the construction without using embodiments. For example, object identifiers (e.g., product identifiers and space identifiers, as discussed above) facilitate more efficient collection and analysis of data analytical metrics with regard to a given defined space, product, delivery, target date, etc. For example, in addition to providing target dates associated with products and deliveries, embodiments generate and use visual characteristics (e.g., color characteristics) to represent the combination of multiple tracked objects and characteristics (e.g., color characteristics assigned to defined spaces based on target dates).

Combining complex data from different sources may be useful to generate a variety of different useful descriptions of reality, e.g., target dates for delivery, analytical reports, trending information based on target dates—the foregoing making the operation of different management more efficient than if performed without the use of embodiments described herein.

Existing/traditional, systems where different sources of construction information are combined do not teach many elements of embodiments described herein. For example, the determination of target dates for delivery and the generation of color characteristics of defined spaces for deliveries is a significant advance in efficiency over traditional approaches.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein.

The breadth and scope of the present invention should not be limited by any of the above-described exemplary embodiments or any actual software code with the specialized control of hardware to implement such embodiments, but should be defined only in accordance with the following claims and their equivalents.

What is claimed is:

1. A computer-implemented method of transforming representations of categories of products assigned to defined spaces within structures into visual maps encoded with color characteristics, the method performed by a processor and comprising:
receiving, by a processor, information defining a floor plan of a building project, the floor plan including a structure and one or more defined spaces within the structure;
identifying, by the processor, for each of the one or more defined spaces, a respective plurality of products to be delivered to the each of the one or more defined spaces;
assigning, by the processor, for each of the plurality of defined spaces, a category to each one of the plurality of products;
identifying, by the processor, for each of the plurality of defined spaces, a target date for each category for each of the defined spaces to which products of the category are to be delivered, the target date being a date associated with the delivery to the respective defined space, of the products to which the category is assigned;
determining, by the processor, for each defined space, a difference between a current date and the one or more target dates associated with categories of products to be delivered to the each defined space;
generating, by the processor, a visual map of the floor plan, the visual map having each of the one or more defined spaces;
determining, by the processor, a color characteristic of each of the one or more defined spaces in the visual map, the color characteristic being determined based on the determined differences between the current date and the one or more target dates associated with categories of products to be delivered to the each of the one or more defined spaces in the visual map; and
causing a display device to display the visual map,
wherein each of the one or more defined spaces is displayed in the visual map based on the respective determined color characteristic.

2. The computer-implemented method of claim 1, wherein:
a first color is associated with a target date that is in the future,
a second color is associated with a target date that is in the past,
a third color is associated with a combination of a target date that is in the past and a delivery status indicating that the products of a category have been delivered, and
a fourth color is associated with a combination of a target date that is in the past and a delivery status indicating that the products of a category have not been delivered.

3. The computer-implemented method of claim 1, wherein target dates are associated with one or more of a target requested for delivery date, a target estimated delivery date, a target purchase date, or a target delivery date to an intermediate location.

4. The computer-implemented method of claim 1, further comprising, assigning a status to a defined space based on the current date, and one or more categories assigned to products to be delivered to the defined space.

5. The computer-implemented method of claim 1, further comprising:
determining one or more date ranges associated with how close a target date of a category is to the present date;
associating a color to each date range different than the color associated with each of the other date ranges; and
generating a key indicating each color and the date range associated with the color.

6. The computer-implemented method of claim 5, further comprising, providing the key to be displayed along with the visual map.

7. The computer-implemented method of claim 1, wherein the determining of the difference between a current date and the target date comprises:
identifying a target date associated with a category in a defined space;
identifying the current date; and
determining a difference in a number of days between the target date and the current date.

8. The computer-implemented method of claim 1, further comprising, determining a target date for the completion of all deliveries to a defined space, the determining being based on targets dates assigned to each category in the defined space.

9. The computer-implemented method of claim 1, wherein one or more target dates are associated with determining that a milestone has been achieved.

10. A system for managing tasks in a building project, the system comprising:
a memory configured to store processor instructions, a plurality of product identifiers, a map of a building, one or more target dates, a plurality of categories, a plurality of defined space identifiers, to identify defined spaces in the building;
a display configured to display the map; and
at least one processor configured, upon execution of the processor instructions, to:
for each of the plurality of defined space identifiers, determine products to be delivered to the each of the defined spaces,
receive and store in the memory, a category for each product determined to be delivered,
receive and store in the memory, a target date assigned to each category in each defined space,
create and store in the memory, the map of the building, the creating of the map being based on the defined spaces in the building,
determine, based on a current date and the target dates associated with categories in each of the defined spaces, a color characteristic for the defined space on the map associated with the current date and target dates of categories in the defined space, and
display, using the display, the map of the building, the map including the defined spaces, and the determined color characteristic for each of the defined spaces.

11. The system of claim 10, wherein:
a first color is associated with a target date that is in the future,
a second color is associated with a target date that is in the past,
a third color is associated with a combination of a target date that is in the past and a delivery status indicating that the products of a category have been delivered, and
a fourth color is associated with a combination of a target date that is in the past and a delivery status indicating that the products of a category have not been delivered.

12. The system of claim 10, wherein target dates are associated with one or more of a target requested for delivery date, a target estimated delivery date, a target purchase date, or a target delivery date to an intermediate location.

13. The system of claim 10, wherein the at least one processor is further configured to assign a status to a defined space based on the current date, and one or more categories assigned to products to be delivered to the defined space.

14. The system of claim 10, wherein the at least one processor is further configured to:
determine one or more date ranges associated with how close a target date of a category is to the present date,
associate a color to each date range different than the color associated with each of the other date ranges, and
generate a key indicating each color and the date range associated with the color.

15. The system of claim 14, wherein the at least one processor is further configured to provide the key to be displayed along with the visual map.

16. The system of claim 10, wherein the determining of the difference between a current date and the target date comprises:
identifying a target date associated with a category in a defined space,
identifying the current date, and
determining a difference in a number of days between the target date and the current date.

17. The system of claim 10, further comprising, determining a target date for the completion of all deliveries to a defined space, the determining being based on targets dates assigned to each category in the defined space.

18. The system of claim 10, wherein one or more target dates are associated with determining that a milestone has been achieved.

19. The system of claim 10, wherein the at least one processor is further configured to generate impact estimates based on at least one target date identified with categories assigned to products to be delivered to at least one defined space.

20. A non-transitory, computer-readable storage medium having instructions stored thereon, the instructions, when executed by a processor, configure the processor to perform a method of transforming representations of categories of products assigned to defined spaces within structures into visual maps encoded with color characteristics, the method performed by the processor and comprising:
receiving information defining a floor plan of a building project, the floor plan including a structure and one or more defined spaces within the structure;
identifying for each of the one or more defined spaces, a respective plurality of products to be delivered to the each of the one or more defined spaces;
assigning for each of the plurality of defined spaces, a category to each one of the plurality of products;
identifying for each of the plurality of defined spaces, a target date for each category for each of the defined spaces to which products of the category are to be delivered, the target date being a date associated with the delivery to the respective defined space, of the products to which the category is assigned;
determining for each defined space, a difference between a current date and the one or more target dates associated with categories of products to be delivered to the each defined space;
generating a visual map of the floor plan, the visual map having each of the one or more defined spaces;
determining a color characteristic of each of the one or more defined spaces in the visual map, the color characteristic being determined based on the determined differences between the current date and the one or more target dates associated with categories of products to be delivered to the each of the one or more defined spaces in the visual map; and
causing a display device to display the visual map,
wherein each of the one or more defined spaces is displayed in the visual map based on the respective determined color characteristic.
